(19) United States
(12) Patent Application Publication
(10) Pub. No.: US 2026/0145831 A1
(43) Pub. Date: May 28, 2026

(54) STRAPPING MACHINE CONFIGURED TO FORM A WELDED STRAP JOINT VIA INDUCTION HEATING

(71) Applicant: Signode Industrial Group LLC, Tampa, FL (US)

(72) Inventor: Jürgen Höhn, Bad Berneck (DE)

(21) Appl. No.: 19/121,332

(22) PCT Filed: Oct. 4, 2023
(86) PCT No.: PCT/US2023/075953

§ 371 Date: Apr. 15, 2025

Related U.S. Application Data
(60) Provisional application No. 63/381,026, filed on Oct. 26, 2022.

(51) Int. Cl. B65B 13/32; B29C 65/32; B65B 13/06

(52) U.S. Cl. CPC B65B 13/32; B65B 13/06; B29C 65/32

(57) ABSTRACT

Various embodiments of the present disclosure provide a strapping machine including a strap-sealing assembly configured to weld two overlapping portions of strap together via induction heating to form a strap joint.

### PRIORITY

This application claims priority to and the benefit of U.S. Provisional Patent Application No. 63/381,026 , filed Oct. 26, 2022, the entire contents of which is incorporated herein by reference.

### FIELD

The present disclosure relates to a strapping machine for bundling and unitizing loads of goods, and more particularly to a strapping machine including a strap-sealing assembly configured to weld two overlapping portions of strap together via induction heating to form a strap joint.

### BACKGROUND

A strapping machine forms a loop of plastic strap (such as polyester or polypropylene strap), metal strap (such as steel strap), or paper strap around a load. A typical strapping machine includes a support surface that supports the load, a strap chute that circumscribes the support surface, a strapping head that forms the strap loop using strap drawn from a strap supply, a controller that controls the strapping head to strap the load, and a frame that supports these components. A typical strapping head includes a strap-feeding assembly for feeding strap from the strap supply into and around the strap chute and for retracting the strap so it exits the strap chute and moves radially inwardly into contact with the load, a strap-tensioning assembly for tensioning the strap around the load, and a strap-sealing assembly for attaching two portions of the strap together to form the strap loop and for cutting the strap from the strap supply. The strapping machine includes several guides that define strap channels that the strap passes through as it moves through the various components of the strapping machine. The strap channels and the strap chute together define a strap path that the strap moves through.

To strap the load, the strapping machine carries out a strapping process including a strap-feeding process, a strap-retraction process, a strap-tensioning process, and a strap-sealing process. The strapping machine first carries out the strap-feeding process during which the strap-feeding assembly feeds strap (with the leading strap end first) from the strap supply through the strap-tensioning assembly, through the strap-feeding assembly, through the strap-sealing assembly, and into and around the strap chute until the leading strap end returns to the strap-sealing assembly. The strapping machine then carries out the strap-retraction process during which the strap-sealing assembly holds the leading strap end while the strap-feeding assembly retracts the strap to pull the strap out of the strap chute and onto and around the load. The strapping machine then carries out the strap-tensioning process during which the strap-tensioning assembly tensions the strap to a designated strap tension. The strapping machine then carries out the strap-sealing process during which the strap-sealing assembly attaches two overlapping portions of the strap to one another to form a strap joint and cuts the strap from the strap supply, thereby forming a strap loop around the load and completing the strapping process.

Certain strapping machines configured for plastic or paper strap include a hot-knife strap-sealing assembly to weld the two overlapping portions of the strap to one another. The strap-sealing assembly includes a workpiece that includes a resistive heating element. In operation, resistive heating element is activated to heat the workpiece, and the heated workpiece is inserted between the two overlapping portions of the strap. A clamp forces the overlapping portions of the strap into contact with the workpiece such that the workpiece melts at least part of each of the overlapping portions of the strap. The clamp is released, and the workpiece is removed from between the overlapping portions of the strap. The clamp then clamps the overlapping portions of the strap together against a counter-pressure plate such that the melted parts of the overlapping portions of the strap join to form a welded strap joint.

There are a few downsides to known hot-knife strap-sealing assemblies. It takes a relatively long time for the resistive heating element to heat the workpiece to the desired temperature. To maintain relatively short cycle times (a cycle time is the time it takes to strap a load), the hot-knife strap-sealing assemblies typically keep the maintain the workpiece at or near its desired temperature between cycles. This requires the resistive heating element to be active almost constantly, which increases energy consumption (and cost) and shortens the lifespan of the heater. To ensure the strap is properly welded, the workpiece must be heated to at least the melting temperature of the strap. To optimize energy consumption and component lifespan, the workpiece would ideally be heated to the melting temperature of the strap. But since it is difficult to control the temperature of the workpiece via the resistive heater, the hot-knife strap-sealing assemblies typically maintain the workpiece at a temperature higher than the welding temperature of the strap. This excessive temperature results in adequate strap joints but can generate undesirable smoke and ash byproducts as the workpiece melts the strap.

### SUMMARY

Various embodiments of the present disclosure provide a strapping machine including a strap-sealing assembly configured to weld two overlapping portions of strap together via induction heating to form a strap joint.

### BRIEF DESCRIPTION OF THE FIGURES

FIG. 1 is a diagrammatic side view of one example embodiment of a strapping machine of the present disclosure.

FIG. 2 is a block diagram showing certain components of the strapping machine of FIG. 1.

FIG. 3A is a side elevational view of a strap clamp of the strap-sealing assembly of the strapping machine of FIG. 1.

FIG. 3B is a cross-sectional top plan view of the strap clamp of FIG. 3A taken substantially along line 3B-3B of FIG. 3A.

FIG. 4 is a flowchart showing a strap-sealing process carried out by the strap-sealing assembly of the strapping machine of FIG. 1.

FIGS. 5A-5G are diagrammatic views of part of the strap-sealing assembly of the strapping machine of FIG. 1 during the strap-sealing process of FIG. 4.

### DETAILED DESCRIPTION

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

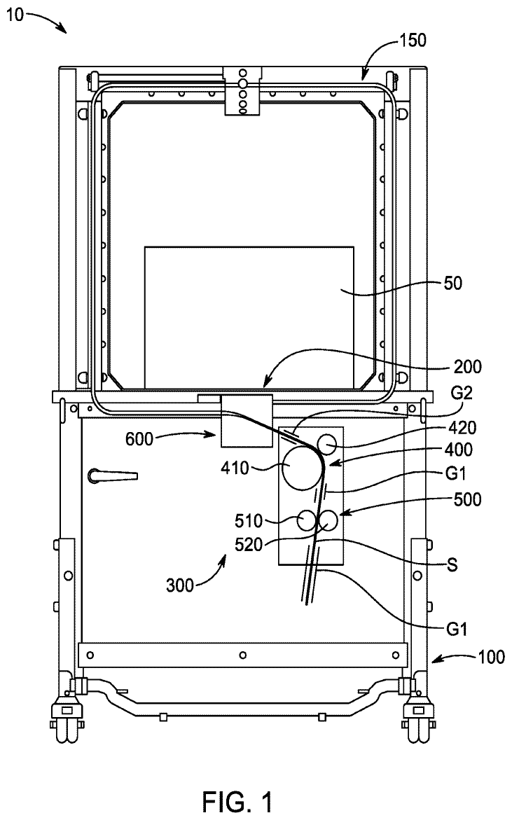

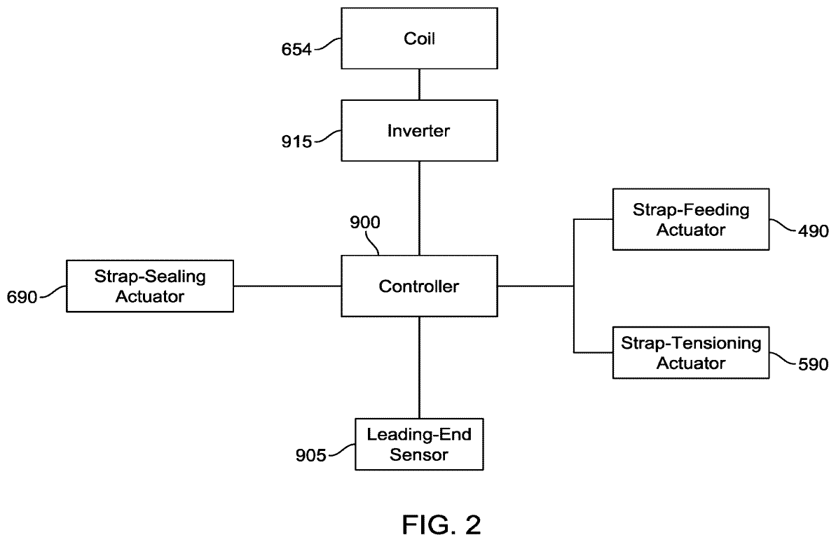

Various embodiments of the present disclosure provide a strapping machine including a strap-sealing assembly configured to weld two overlapping portions of strap together via induction heating to form a strap joint. FIGS. 1-3B and 5A-5G show one example embodiment of a strapping machine 10 of the present disclosure and components thereof. The strapping machine 10 includes a frame 100, a strap chute 150, a load supporter 200, a strapping head 300, a controller 900, strap guides G1 and G2, and one or more sensors. The strapping machine 10 is configured to strap loads with strap drawn from a strap supply (not shown), such as a coil of strap mounted to the frame 100.

The frame 100 supports some (or all depending on the embodiment) of the other components of the strapping machine 10 and may be formed of any suitable components arranged in any suitable configuration. The load supporter 200 is supported by the frame 100 and is sized, shaped, positioned, oriented, and otherwise configured to support loads-such as the load 50 shown in FIG. 1—as they are strapped by and as they move through the strapping machine 10. The load supporter 200 includes a support surface (not labeled) on which loads are positioned during strapping and over which loads move as they move through the strapping machine 10. In this example embodiment, the support surface includes multiple rollers that facilitate movement of the loads across the load supporter 200. The rollers may be driven or undriven. In other embodiments, the support surface includes any other suitable driven conveyor.

The strap chute 150 is supported by the frame 100 and circumscribes the support surface of the load supporter 200. The strap chute 150 defines a strap path that the strap follows when fed through the strap chute 150 and from which the strap is removed when retracted. The strap chute 150 includes two spaced-apart first and second upstanding legs (not labeled); an upper connecting portion (not labeled) that spans the first and second legs; a first lower connecting portion (not labeled) within or beneath the load supporter 200 that connects the strapping head 300 with the first upstanding leg; and a second lower connecting portion (not labeled) within or beneath the load supporter 200 that connects the strapping head 300 with the second upstanding leg. The radially inward wall of the strap chute 150 is formed from one or more gates that are spring biased to a closed position that enables the strap to traverse the strap path when fed through the strap chute 150. When the strap-feeding assembly 400 exerts a pulling force on the strap to retract the strap, the pulling force overcomes the biasing force of the springs and causes the gate(s) to pivot to an open position, thereby releasing the strap from the strap chute 150 so the strap moves radially inward into contact with the load. A leading-end sensor 905 communicatively connected to the controller 900 is positioned and otherwise configured to detect the leading end of the strap when the leading end has traversed the strap chute 150 and returned to the strapping head 300, as explained below.

The strapping head 300 is configured to carry out the strapping process. The strapping head 300 is mounted to the frame 100 and includes a strap-feeding assembly 400, a strap-tensioning assembly 500, and a strap-sealing assembly 600.

The strap-feeding assembly 400 is configured to feed strap from the strap supply into and around the strap chute 150 and to, after the leading-end sensor 905 senses the leading end of the strap and the strap-sealing assembly 600 holds the leading end, retract the strap so it exits the strap chute 150 and contacts the load 50. The strap-feeding assembly 400 includes a drive roller 410, a pinch roller 420, and a strap-feeding actuator 430. The drive roller 410 is cylindrical (here, disc-shaped) and is rotatable about a drive-roller rotational axis. The pinch roller 420 is cylindrical (here, disc-shaped) and is freely rotatable about a pinch-roller rotational axis. The drive roller 410 and the pinch roller 420 are sized, shaped, positioned, and oriented such that their respective rotational axes are generally parallel and coplanar. The pinch roller 420 is positioned adjacent the drive roller 410 such that a nip is formed between the two rollers. The nip is sized such that the strap can be received in the nip and such that the drive roller 410 and the pinch roller 420 apply sufficient force to the strap to enable the drive roller 410 to feed and retract the strap around the load. In certain embodiments, at least part of the external cylindrical surface of the drive roller 410 and/or the pinch roller 420 is knurled or coated with a friction-enhancing material to facilitate engaging and dispensing the strap.

The strap-feeding actuator 430, which is an electric motor in this example embodiment but may include any suitable actuator, is operably connected to the drive roller 410 and configured to drive the drive roller 410 in opposing feed and retract rotational directions. The strap-feeding actuator 430 may be operably connected to the drive roller 410 in any suitable manner, such as via a keyed or splined connection and/or via a suitable drive train.

The strap-tensioning assembly 500 is configured to tension the strap around the load 50. The strap-tensioning assembly 500 includes a drive roller 510, a pinch roller 520, and a strap-tensioning actuator 530. The drive roller 510 is cylindrical (here, disc-shaped) and is rotatable about a drive-roller rotational axis. The pinch roller 520 is cylindrical (here, disc-shaped) and is freely rotatable about a pinch-roller rotational axis. The drive roller 510 and the pinch roller 520 are sized, shaped, positioned, and oriented such that their respective rotational axes are generally parallel and coplanar. The pinch roller 520 is also movable relative to the drive roller 510 between a tensioning position and a spaced position (not shown). When the pinch roller 520 is in the tensioning position, the pinch roller 520 is adjacent the drive roller 510 such that a nip is formed between the two rollers. The nip is sized such that the strap can be received in the nip and such that the drive roller 510 and the pinch roller 520 apply sufficient force to the strap to enable the drive roller 510 to tension the strap around the load. When the pinch roller 520 is in the spaced position, the pinch roller 520 is spaced-apart from the drive roller 510 such that the strap can pass freely between the two rollers. In this example embodiment, the pinch roller 520 is in the spaced position except during the strap-tensioning process, during which the pinch roller 520 is in the tensioning position. In certain embodiments, at least part of the external cylindrical surface of the drive roller 510 and/or the pinch roller 520 is knurled or coated with a friction-enhancing material to facilitate engaging and dispensing the strap.

The strap-tensioning actuator 530, which includes an electric motor in this example embodiment but may include any suitable actuator, is operably connected to the drive roller 510 and configured to drive the drive roller 510 in a tensioning rotational direction (which is the same rotational direction as the retract rotational direction in this example embodiment). The strap-tensioning actuator 530 may be operably connected to the drive roller 510 in any suitable manner, such as via a keyed or splined connection and/or via a suitable drive train.

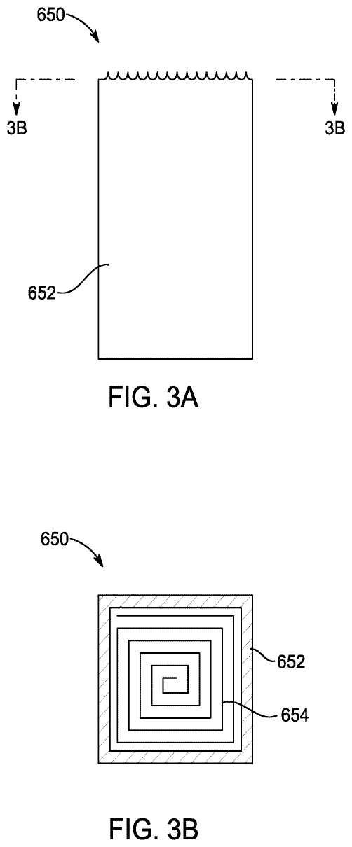

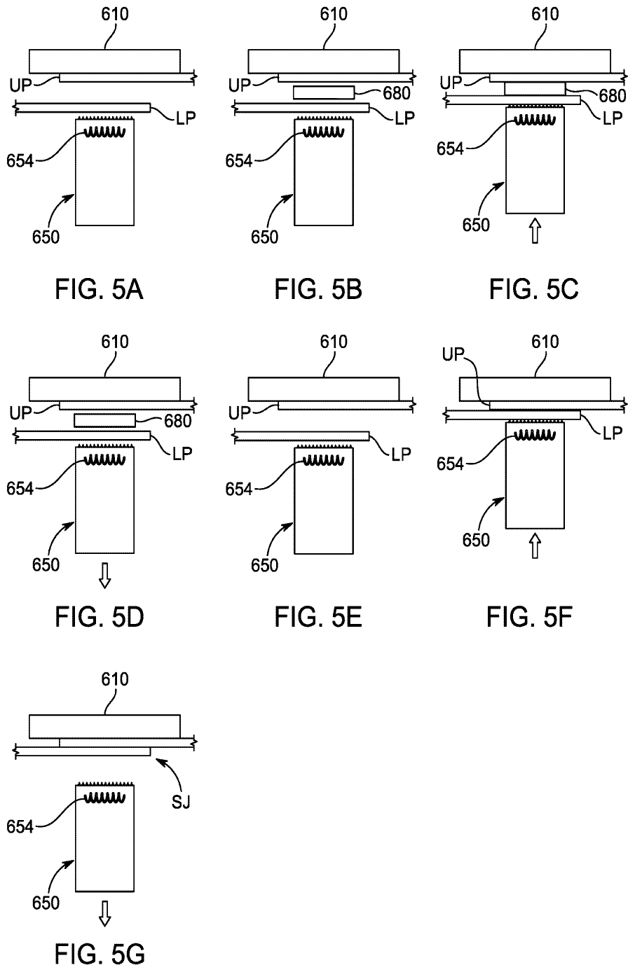

The strap-sealing assembly 600 is configured to, after the strap-tensioning assembly 500 tensions the strap to the designated tension, attach two overlapping portions of the strap to one another and cut the strap from the strap supply. As best shown in FIGS. 3A, 3B, and 5A-5G, the strap-sealing assembly 600 includes a counter-pressure plate 610, a strap clamp 650, a workpiece 680, and a strap-sealing actuator 690.

The counter-pressure plate 610 is movable between a home position (FIGS. 5A-5G) and a retracted position (not shown). The counter-pressure plate 610 is in the home position during the strapping process and is moved to the retracted position after the strap-sealing process is complete to release the tensioned strap loop so the load can be removed from the strapping machine 10. As best shown in FIGS. 3A and 3B, the strap clamp 650 includes a body 652 having a clamping surface 652s at one end. The body 652 defines a cavity housing a coil 654 underneath the clamping surface 652s. The coil 654 is a spiral square coil in this example embodiment, though it may be any other suitably shaped type of coil in other embodiments. The coil 654 is formed from a suitable electrically conductive material, such as metal wire or tubing. The strap clamp 650 is movable relative to the counter-pressure plate 610 among a home position (FIGS. 5A, 5B, 5D, 5E, and 5G); a first clamping position (FIG. 5C); and a second clamping position (FIG. 5F). The workpiece 680 is formed from a suitable electrically conductive material and movable relative to the counter-pressure plate 610 and the strap clamp 650 between a home position (FIGS. 5A and 5E-5G) and a sealing position (FIGS. 5B-5D).

The strap-sealing actuator 690, which is an electric motor in this example embodiment but may include any suitable actuator, is operably connected to and configured to move the above components of the strap-sealing assembly 600 to carry out the strap-sealing process.

Generally, the strap-feeding assembly 400, the strap-tensioning assembly 500, and the strap-sealing assembly 600 are together configured to form a tensioned strap loop around the load 50 by drawing strap from the strap supply and feeding it through the strap chute 150 in a feed direction, holding the leading strap end while retracting the strap in the retract direction to remove it from the strap chute 150 so it contacts the load 50, tensioning the strap around the load 50 to a designated tension, attaching two overlapping portions of the strap to one another to form a strap joint, and cutting the strap from the strap supply. In this example embodiment, the strapping machine 10 is a “tabletop” strapping machine in which the frame 100 supports the strap-feeding assembly 400, the strap-tensioning assembly 500, and the strap-sealing assembly 600. In other embodiments, one or more of these assemblies is not supported by the frame 100. For instance, in certain embodiments in which the strapping machine is configured to strap large loads, such as palletized loads, loads of lumber, or loads of corrugated, these assemblies are distinct, independently replaceable modules supported by different components of the strapping machine.

As best shown in FIG. 1, the first strap guide G1 extends from the strap supply (not shown) through the strap-tensioning assembly 500 and to the strap-feeding assembly 400 and is configured to guide the strap as it moves between those components. The second strap guide G2 extends between the strap-feeding assembly 400 and the strap-sealing assembly 600 and is configured to guide the strap as it moves between those components.

The controller 900 includes a processing device (or devices) communicatively connected to a memory device (or devices). For instance, the controller 900 may be a programmable logic controller. The processing device may include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine. The memory device may include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. The memory device stores instructions executable by the processing device to control operation of the strapping machine 10, such as to carry out the strap-sealing process 1000 described below.

The inverter 915 is a suitable inverter configured to convert a direct-current power supply to an alternating current output at one of multiple different frequencies (the frequency of the alternating current the rate at which current changes direction per second). The inverter 915 is electrically connected to the coil 654 such that that alternating current output by the inverter 915 flows to and through the coil 654 to heat the workpiece 680 via induction, as described below. Each of the multiple different frequencies of alternating current that the inverter 915 is capable of outputting is associated with a different temperature to which the workpiece 680 can be heated. For instance, a first frequency is associated with a first temperature, a second different frequency is associated with a second different temperature, a third different frequency is associated with a third different temperature, and so on. In other embodiments the strapping machine does not include an inverter and routes the existing alternating current to the coil 654.

The controller 900 is operably connected to the inverter 915 and configured to control the inverter 915 to operate with the coil 654 to heat the workpiece 680 via induction. Specifically, to heat the workpiece 680 to a first temperature, the controller 900 controls the inverter 915 to convert a direct-current power supply to an alternating current output at a first frequency. This alternating current flows to and through the electrically conductive coil 654, which generates a magnetic field around the coil 654. When the electrically conductive workpiece 680 is positioned close enough to the strap clamp 650 such that it is positioned within the magnetic field around the coil 654, the magnetic field induces eddy currents in the workpiece 680, and the workpiece 680 heats up due to the internal resistance to the flow of the induced eddy currents. In this instance, the workpiece 680 heats up to the first temperature since the inverter 915 outputs the alternating current to the coil 654 at the first frequency.

The particular frequency associated with a particular temperature of the workpiece may vary depending on a variety of factors, such as the distance between the workpiece and the coil, the material of the strap clamp, the material of the workpiece, and the external environment (such as the humidity).

The controller 900 is also operably connected to the strap-feeding actuator 430, the strap-tensioning actuator 530, and the strap-sealing actuator 690 and is configured to control the output of these actuators. The controller 900 is communicatively connected to and configured to receive signals from and send signals to the leading-end sensor 905.

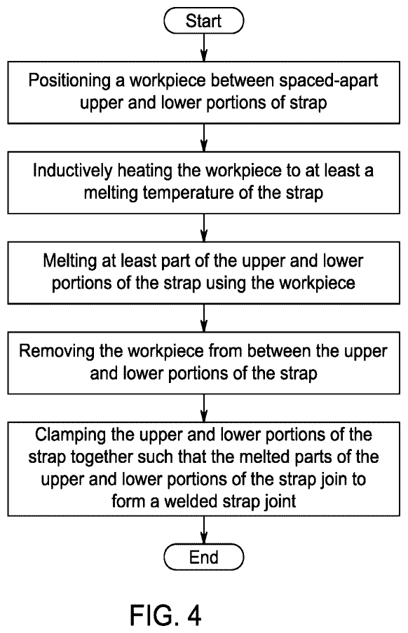

Operation of the strapping machine 10 to carry out a strapping process is now described. During the strapping process, the strapping machine 10 is configured to carry out: (1) a strap-feeding process by feeding strap from the strap supply around the strap chute 150 that surrounds the load 50; (2) a strap-retraction process by pulling the strap out of the strap chute 150 and onto and around the load 50; (3) a strap-tensioning process by tensioning the strap around the load 50 to a designated strap tension; and (4) a strap-sealing process 1000 (FIG. 4) by attaching two overlapping portions of the strap to one another via induction welding to form a strap joint.

After initiation of the strapping process, the controller 900 initiates the strap-feeding process and drives the strap-feeding actuator 430 to drive the drive roller 410 in the feed rotational direction to feed the strap S from the strap supply in the feed direction through the strap guide G1, between the drive roller 510 and the pinch roller 520 of the strap-tensioning assembly 500, through the strap guide G1, between the drive roller 410 and the pinch roller 420 of the strap-feeding assembly 400, through the strap guide G2, and through the strap-sealing assembly 600 and into and around the strap chute 150. The leading end of the strap S eventually returns to the strap-sealing assembly 600, at which point the leading-end sensor 905 senses the leading end and sends an appropriate signal to the controller 900. In response, the controller 900 stops driving the strap-feeding actuator 430 to stop the drive roller 410 and complete the strap-feeding process.

After the strap-feeding process is complete, the controller 900 initiates the strap-retraction process and drives the strap-sealing actuator 690 to cause the strap-sealing assembly 600 to clamp part of the strap S near the leading end. The controller 900 then drives the strap-feeding actuator 430 to drive the drive roller 410 in the retract rotational direction to pull the first strap S1 in the retract direction and out of the strap chute 150 and onto and around the load, at which point the controller 900 stops driving the strap-feeding actuator 430 to stop the drive roller 410 and complete the strap-retraction process.

After the strap-retraction process is complete, the controller 900 initiates the strap-tensioning process and drives the strap-tensioning actuator 530 to drive the drive roller 510 in the tensioning rotational direction to pull the strap S in the retract direction and tension the strap S1 around the load. As this occurs, the controller 900 monitors the electrical current drawn by the strap-tensioning actuator 530. Once the current draw reaches a predetermined amount that is correlated with a predetermined strap tension, the controller 900 stops driving the strap-tensioning actuator 530 to stop the drive roller 510 and complete the strap-tensioning process.

After the strap-tensioning process is complete, the controller 900 initiates the strap-sealing process 1000 and drives the strap-sealing actuator 690 and controls the inverter 915 to cause the strap-sealing assembly 600 to attach two overlapping portions of the strap to one another via induction welding to form a strap joint and to cut the strap S from the strap supply to complete the strap-sealing process.

The strap-sealing process 1000 is now described in detail with respect to the flowchart in FIG. 4. Before initiation of the strap-sealing process 1000, the strap has been tensioned around the load, and overlapping spaced-apart upper and lower portions of the strap are held in place. Upon initiation of the strap-sealing process 1000, a workpiece is positioned between the spaced-apart upper and lower portions of the strap, as block 1010 indicates. The workpiece is inductively heated to a designated temperature that is at least equal to a melting temperature of the strap, as block 1020 indicates. At least part of the upper and lower portions of the strap are melted using the workpiece, as block 1030 indicates. The workpiece is removed from between the upper and lower portions of the strap, as block 1040 indicates. The upper and lower portions of the strap are clamped together such that the melted parts of the upper and lower portions of the strap joint form a welded strap joint, as block 1050 indicates.

An example implementation of the strap-sealing process 1000 by the strapping machine 10 is now described with reference to FIGS. 5A-5G. In this example embodiment, the designated temperature is equal to or slightly higher than the melting temperature of the strap S. As shown in FIG. 5A, before initiation of the strap-sealing process 1000, overlapping upper and lower portions UP and LP of the strap S are spaced-apart and held in place between the counter-pressure plate 610 and the strap clamp 650 and the counter-pressure plate 610, the strap clamp 650, and the workpiece 680 are at their respective home positions. Additionally, the temperature of the workpiece 680 is below the melting point of the strap S. Upon initiation of the strap-sealing process 1000, the controller 900 controls the strap-sealing actuator 690 to move the workpiece 680 to its sealing position, as shown in FIG. 5B. The controller 900 also controls the inverter 915 to output alternating current at a frequency that correlates to the designated temperature to the coil 654. In this example embodiment, when the workpiece 680 is in the sealing position and the strap clamp 650 is in the home position, the workpiece 680 is positioned within the magnetic field generated around the coil 654, causing the workpiece 680 to begin heating to the designated temperature. The controller 900 controls the strap-sealing actuator 690 to move the strap clamp 650 to the first clamping position, as shown in FIG. 5C, such that the strap clamp 650 forces the upper and lower portions UP and LP of the strap S against the upper and lower surfaces of the workpiece 680, respectively. By this time, the workpiece 680 has reached the designated temperature, and the workpiece 680 melts the parts of the upper and lower portions UP and LP of the strap S contacting the workpiece 680.

The controller 900 controls the strap-sealing actuator 690 to move the strap clamp 650 and the workpiece 680 back to their respective home positions to release the upper and lower portions UP and LP of the strap S, as shown in FIGS. 5D and 5E. The controller 900 also controls the inverter 915 to stop outputting alternating current to the coil 654, enabling the workpiece 680 to begin cooling (eventually to a temperature below the designated temperature). The controller 900 controls the strap-sealing actuator 690 to move the strap clamp 650 to the second clamping position, as shown in FIG. 5F to clamp the upper and lower portions UP and LP of the strap S together and against the underside of the counter-pressure plate 610, as shown in FIG. 5F. This forces the melted parts of the upper and lower portions UP and LP of the strap S together such that, as the strap cools, they join to form a welded strap joint SJ. The controller 900 controls the strap-sealing actuator 690 to move the strap clamp 650 to its home position to release the strap joint SJ, as shown in FIG. 5G, and then to move the counter-pressure plate to its retracted position (not shown) to enable the load to be removed from the load supporter 200.

In the example embodiment described above, the coil is part of the strap clamp. In other embodiments, the coil may be part of or supported another component of the strapping machine close to the overlapping portions of the strap to-be-welded, such as the counter-pressure plate. In various embodiments, the strap-sealing assembly includes multiple coils, such as one coil as part of the strap clamp and another as part of the counter-pressure place. In some of these embodiments, the strap clamp includes two coils for redundancy.

In the example embodiment described above, the workpiece between the overlapping strap portions is heated. In other embodiments, the workpiece includes the coil and the components on the outsides of the upper and lower strap portions are heated by induction. For instance, the counter-pressure plate and the strap clamp are formed from electrically conductive material and heated via induction when the inverter delivers alternating current to the coil in the workpiece.

In various embodiments, the counter-pressure plate and/or the strap clamp (or the upper portion of the strap clamp surrounding the coil) is formed from a material that is not electrically conductive, such as plastic or ceramic.

1. A strapping device comprising:
a movable workpiece;
a movable strap clamp;
a coil; and
a controller configured to, with the workpiece positioned between a first strap portion and a second strap portion:
control alternating electric current to be output to the coil, thereby causing the workpiece to be heated by induction such that part of the first strap portion and part of the second strap portion melt;
cause the workpiece to be removed from between the first and second strap portions; and
cause the strap clamp to move to clamp the first and second strap portions together such that the melted parts of the first and second strap portions join to form a welded strap joint.

2. The strapping device of claim 1, further comprising an inverter configured to output the alternating electric current to the coil at a designated frequency, wherein the controller is configured to control the inverter to output the alternating electric current to the coil at the designated frequency, thereby causing the workpiece to be heated by induction to a designated temperature.

3. The strapping device of claim 2, wherein the designated temperature is no less than a melting temperature of the strap.

4. The strapping device of claim 3, wherein the workpiece is at a temperature less than the melting temperature of the strap before the controller begins controlling the inverter to output the alternating electric current to the coil at the designated frequency.

5. The strapping device of claim 1, wherein the strap clamp comprises the coil.

6. The strapping device of claim 1, further comprising a counter-pressure plate, wherein the workpiece is between the strap clamp and the counter-pressure plate, wherein the controller is configured to cause the strap clamp to move to clamp the first and second strap portions together and against the counter-pressure plate such that the melted parts of the first and second strap portions join to form a welded strap joint.

7. The strapping device of claim 6, wherein the strap clamp comprises the coil.

8. The strapping device of claim 6, wherein the counter-pressure plate comprises the coil

9. The strapping device of claim 1, wherein the controller is further configured to cause the strap clamp to move to cause the first and second strap portions to contact the workpiece such that the parts of the first and second strap portions melt.

10. The strapping device of claim 1, further comprising an actuator, wherein the controller is configured to control the actuator to cause the workpiece to be removed from between the first and second strap portions and to cause the strap clamp to move to clamp the first and second strap portions together.

11. A strap-sealing process comprising:
with a workpiece positioned between a first strap portion and a second strap portion, heating the workpiece by induction such that part of the first strap portion and part of the second strap portion melt;
removing the workpiece from between the first and second strap portions; and
moving a strap clamp to clamp the first and second strap portions together such that the melted parts of the first and second strap portions join to form a welded strap joint.

12. The strap-sealing process of claim 11, further comprising outputting, by an inverter, alternating electric current to a coil at a designated frequency to cause the workpiece to be heated by induction.

13. The strap-sealing process of claim 12, wherein heating the workpiece by induction comprises heating the workpiece by induction to a designated temperature that is no less than a melting temperature of the strap.

14. The strap-sealing process of claim 12, wherein the strap clamp comprises the coil.

15. The strap-sealing process of claim 12, further comprising moving the strap clamp to clamp the first and second strap portions together and against a counter-pressure plate such that the melted parts of the first and second strap portions join to form a welded strap joint.

16. The strap-sealing process of claim 15, wherein the strap clamp comprises the coil.

17. The strap-sealing process of claim 15, wherein the counter-pressure plate comprises the coil.

18. The strap-sealing process of claim 12, further comprising moving the strap clamp to cause the first and second strap portions to contact the workpiece such that the parts of the first and second strap portions melt.

19. The strap-sealing process of claim 12, further comprising ceasing output of the alternating electric current to the coil moving the strap clamp to clamp the first and second strap portions together.

20. The strap-sealing process of claim 12, further comprising controlling an actuator to remove the workpiece from between the first and second strap portions and to move the strap clamp to clamp the first and second strap portions together.
